(19) United States
(12) Patent Application Publication
(10) Pub. No.: US 2020/0373996 A1
(43) Pub. Date: Nov. 26, 2020

(54) SYSTEM FOR REAL-TIME TRANSMISSION OF LARGE-CAPACITY OF DEEP-SEA SUBSURFACE MOORING BASED ON BEIDOU SATELLITE

(71) Applicant: The Institute of Oceanology, Chinese Academy of Sciences, Qingdao (CN)

(72) Inventors: Jianing Wang, Qingdao (CN); Xiangguang Zhang, Qingdao (CN); Fan Wang, Qingdao (CN)

(21) Appl. No.: 16/878,767

(22) Filed: May 20, 2020

(30) Foreign Application Priority Data
May 21, 2019 (CN) 201910421452. X

(51) Int. Cl. H04B 7/185; H04B 1/3816; H04W 12/10; H04W 52/02

(52) U.S. Cl. CPC H04B 7/1851; H04B 1/3816; H04W 52/0261; H04W 12/1006; H04W 12/1008; H04B 7/18532

(57) ABSTRACT

The present invention discloses a system for real-time transmission of large-capacity of a deep-sea subsurface mooring based on a Beidou satellite. Data transmission is implemented by a mechanism of single module multi-card switching operation and dynamic subcontracting transmission. A receiving module is connected to a fixed card and is responsible for receiving state information on whether the transmission is successful. A subsurface mooring end antenna and a land-based antenna adopt a network analyzer to perform secondary matching on parameters such as frequency offset and impedance of the assembled antenna, and effectively intercept original data. In addition, arithmetic coding and dictionary coding are adopted for data compression. While an acquisition board terminal processes original valid data, the valid data is compressed to a maximum of one third of the original data, which can be extended into a parallel mode of multiple single-mode multi-card modules.

### CROSS REFERENCE TO RELATED APPLICATIONS

This application claims priority, and benefit under 35 U.S.C. § 119(e) of Chinese Patent Application No. 201910421452.X filed 21 May 2019. The disclosure of the prior application is hereby incorporated by reference as if fully set forth below.

### TECHNICAL FIELD

The present invention belongs to the technical field of communication and relates to a system for real-time transmission of large-capacity of a deep-sea subsurface mooring based on a Beidou satellite.

### BACKGROUND

In order to test technical indexes, overall performance and system reliability of a subsurface mooring for real-time communication, an Iridium system of the United States is currently used for data transmission. Because a test sea area is located in the international sea area, and the deep sea real-time data only serves scientific research and climate prediction at this stage, it does not involve national security. However, a test network will focus on the application requirements of national security. Under such circumstances, the real-time transmission of deep-sea data can no longer rely on the Iridium system of the United States. Otherwise, the United States can steal or tamper with the data at any time. In case of emergency, the satellite transmission may also be interrupted, seriously damaging China's national security. Therefore, the transmission of deep-sea real-time data must be ensured to be safe, autonomous and controllable. The use of the Beidou satellite independently developed by China is a must. Beidou Satellite Navigation System (BDS) is an independently developed and independently operated global satellite navigation system currently being implemented in China. It forms four major global satellite navigation systems with the US Global Positioning System, Russian Glonass and European Union Galileo Satellite Navigation System. BDS is composed of three parts: a space segment, a ground segment and a user segment. It can provide high-precision and reliable positioning, navigation, time service and short message communication functions for users with various needs in the global scope in all weather and all day. Moreover, it preliminarily has regional navigation, positioning and time service capabilities. However, the Beidou satellite has limited data transmission capacity. A single card can transmit 78 bytes per minute, and the data volume of two 75 kHz acoustic Doppler current profilers (ADCPs) on a subsurface mooring is 2708 bytes per hour. Even if only the above data transmission is realized, it takes about 35 minutes. If a satellite signal is weak or unstable, or other devices are added, the data transmission time is longer, which result in that the data cannot be transmitted in real time, or the system power consumption is too high to be applied to a subsurface mooring platform. Therefore, it is an inevitable choice to develop a highly integrated Beidou multi-card module to improve the data transmission rate. Meanwhile, it is necessary to effectively compress original observation data. Although there are similar products in the market, the existing products can only be applied to ship-borne platforms with self-generating capacity. The products are large in volume and high in power consumption, and cannot be applied to deep-sea subsurface mooring platforms. Therefore, how to reduce the volume and power consumption becomes another challenge. In view of the foregoing problems, this project develops a Beidou multi-card system for real-time transmission of large-capacity of a deep-sea subsurface mooring to realize safe, autonomous and controllable transmission of deep-sea data.

### SUMMARY

The present invention provides a system for real-time transmission of large-capacity of a deep-sea subsurface mooring based on a Beidou satellite. The technical solution adopted by the present invention is that data transmission is implemented by a mechanism of single module multi-card switching operation and dynamic subcontracting transmission. A receiving module is connected to a fixed card and is responsible for receiving state information on whether the transmission is successful, and a corresponding effective bidirectional response verification mechanism is adopted to ensure the integrity and real-time property of the data. A subsurface mooring end antenna and a land-based antenna adopt a network analyzer to perform secondary matching on parameters such as frequency offset and impedance of the assembled antenna, and effectively intercept original data; arithmetic coding and dictionary coding are adopted for data compression; while an acquisition board terminal processes original valid data, the valid data is compressed to a maximum of one third of the original data, which is suitable for real-time transmission of large-capacity of the deep-sea subsurface mooring, has certain expansion capability, can be extended into a parallel mode of multiple single-mode multi-card modules, and is suitable for low power consumption design of a deep-sea subsurface mooring mobile platform: a processor with a low power consumption MCU and a low power consumption on-duty circuit are adopted, the power consumption is less than 5 uA when the system is in a sleep state, and a Beidou communication module is awakened by timing of an observation device and a data acquisition board.

Further, in the process of data transmission, the module adopts the subcontracting transmission mechanism of a sliding window, which reduces working time of the communication module to the minimum; a sliding window protocol is that at any time, a sender maintains a serial number of a continuous frame allowed to be sent, which is called a sending window; at the same time, a receiver also maintains a serial number of a continuous frame allowed to be received, which is called a receiving window; upper and lower bounds of the serial numbers of the sending window and the receiving window are not necessarily the same; windows with different sliding window protocols are generally different in size, the serial number in the sending window represents those frames that have been sent but have not been confirmed, or those frames that can be sent; and the sliding window mechanism provides a reliable flow control mechanism for data transmission between end-to-end devices.

Further, the system is suitable for small-volume design of the deep-sea subsurface mooring mobile platform: in order to be suitable for a narrow space in a water surface buoy, a solution of separating a communication module board from an SIM card board, and double-layer circuit boards are superposed, thus greatly reducing the overall volume of the module; this is suitable for internal structures of various water surface buoys at present; the single-mode multi-card module retains all functional parameters of a single card; the highly integrated system can not only provide continuous positioning and speed measurement capability for users, but also can perform high-security level position reporting without information transmission; and the navigation and communication are integrated to be embedded into each other and mutually enhanced.

Further, an acquisition board interface of a data acquisition system adopts a universal RS232 interface, and a software interface is compatible with a 75 kHz ADCP, a conductivity-temperature-depth sensor and a deep-sea single point current meter for data acquisition; The interface of the data acquisition board is a standard 232 interface, which is compatible with different models of sound communication devices of different manufacturers, thereby facilitating extension of underwater data transmission applications at various transmission distances; at the same time, other models of underwater sensor interfaces are reserved for future extension; when in connection, it is only necessary to provide a communication protocol for docking; and an overwater acquisition board and a Beidou single-mode multi-card communication module realize bidirectional communication, which facilitates subsequent control over various parameters of sensors through a remote server.

### BRIEF DESCRIPTION OF THE DRAWINGS

FIG. 1 is a schematic diagram of an on-duty circuit using an STM8L solution;

FIG. 2 is a schematic diagram of a single-mode multi-card Beidou module circuit board; and

FIG. 3 is a schematic design diagram of a data acquisition board.

### DETAILED DESCRIPTION

The following describes the present invention in detail with reference to specific implementations.

In the present invention, data transmission is implemented by a mechanism of single module multi-card switching operation and dynamic subcontracting transmission. A receiving module is connected to a fixed card and is responsible for receiving state information on whether the transmission is successful, and one module is connected to 12 cards and used for circularly transmitting data packets. In this way, the goal of completing transmission at a 75 kHz ADCP per hour within one minute can be achieved, thus effectively improving the real-time performance of the data. At present, as the small number of Beidou satellites, unstable signals and frequent data packet missing, this solution provides a corresponding effective bidirectional response verification mechanism to ensure the integrity and real-time property of the data. A subsurface mooring end antenna and a land-based antenna are integrally deeply optimized and modulated according to the actual Beidou satellite network situation and a water surface floating body material to achieve the best matching effect between the antenna and a device, and a network analyzer is adopted to perform secondary matching on parameters such as frequency offset and impedance of the assembled antenna. Original data is effectively intercepted, and arithmetic coding and dictionary coding and other modes are adopted for data compression. While an acquisition board terminal processes original valid data, the valid data is compressed to a maximum of about one third of the original data. This is suitable for real-time transmission of large-capacity of the deep-sea subsurface mooring, has certain expansion capability, can be extended into a parallel mode of multiple single-mode multi-card modules. The single-mode multi-card mode is suitable for the transmission of a current subsurface mooring data volume. When this data volume is subsequently exceeded, a parallel mode of multiple double-card multi-mode modules can be adopted, which facilitates subsequent extended application.

The system is suitable for low power consumption design of a deep-sea subsurface mooring mobile platform: it is planned to adopt a processor with a low power consumption MCU and develop a low power consumption on-duty circuit, the power consumption is less than 5 uA when the system is in a sleep state, and a Beidou communication module is awakened by timing of an observation device and a data acquisition board. The MCU adopts STM8L series low power consumption chips. In an operation mode, the power consumption is as low as 150 μA/MHz. SMT8L provides four low power consumption modes. In the low power consumption mode retained by SRAM data, the power consumption is only 350 nA.

In the process of data transmission, the module adopts a sliding window subcontracting transmission mechanism, so that the working time of the communication module is reduced to a minimum, and a reliable flow control mechanism is provided. Meanwhile, the low power consumption requirement of a subsurface mooring system can be met. A basic principle of the sliding window protocol is that at any time, a sender maintains a serial number of a continuous frame allowed to be sent, which is called a sending window; at the same time, a receiver also maintains a serial number of a continuous frame allowed to be received, which is called a receiving window. Upper and lower bounds of the serial numbers of the sending window and the receiving window are not necessarily the same, and even the sizes can be different. Windows with different sliding window protocols are generally different in size. The serial number in the sending window represents those frames that have been sent but have not been confirmed, or those frames that can be sent. The sliding window mechanism provides a reliable flow control mechanism for data transmission between end-to-end devices.

The system is suitable for small-volume design of the deep-sea subsurface mooring mobile platform: in order to be suitable for a narrow space in a water surface buoy, a solution of separating a communication module board from an SIM card board, and double-layer circuit boards are superposed, thus greatly reducing the overall volume of the module; this is suitable for internal structures of various water surface buoys at present. The single-mode multi-card module retains all functional parameters of a single card. The highly integrated system can not only provide continuous positioning and speed measurement capability for users (namely so-called passive navigation positioning), but also can perform high-security level position reporting without information transmission. The navigation and communication are integrated to be embedded into each other and mutually enhanced.

An acquisition board interface of a data acquisition system adopts a universal RS232 interface, and a software interface is compatible with a 75 kHz ADCP, a conductivity-temperature-depth sensor and a deep-sea single point current meter for data acquisition. The interface (standard 232 interface) of the data acquisition board is compatible with different models of sound communication devices of different manufacturers, thereby facilitating extension of underwater data transmission applications at various transmission distances. At the same time, other models of underwater sensor interfaces, such as a 485 interface, a 4-20 ma interface and a 0-5 V interface, are reserved for future extension; when in connection, it is only necessary to provide a communication protocol for docking. An overwater acquisition board and a Beidou single-mode multi-card communication module realize bidirectional communication, which facilitates subsequent control over various parameters (such as sampling frequency of an observation device, satellite data reporting frequency and echo signal strength screening) of sensors through a remote server.

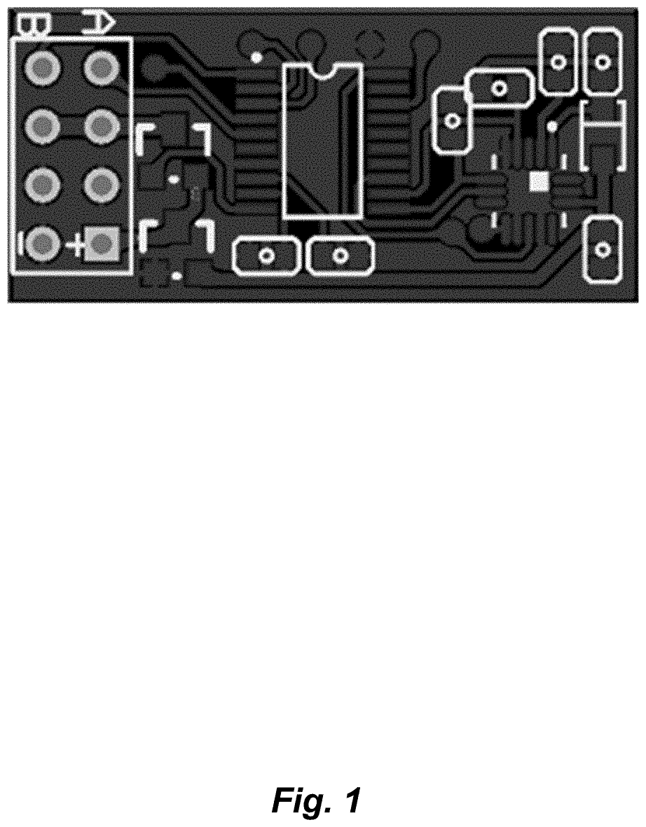

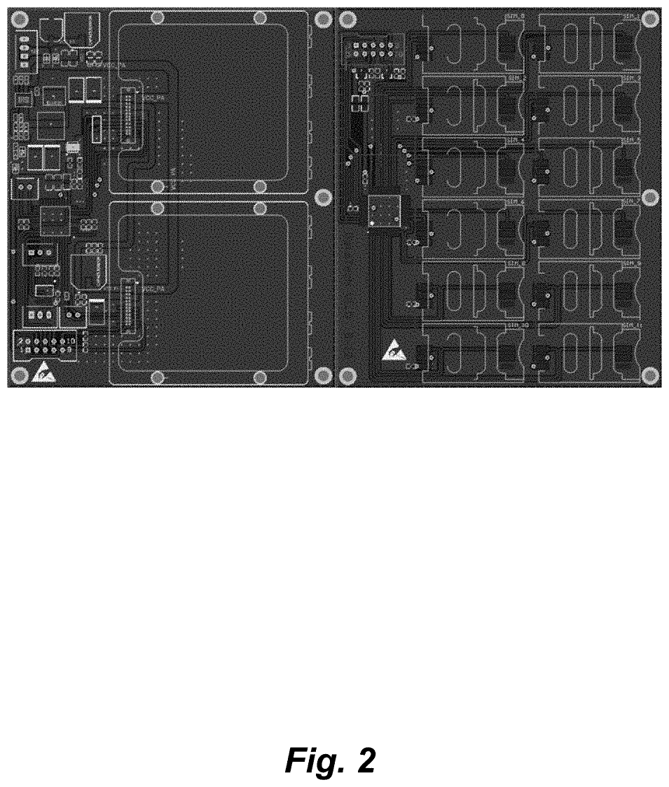

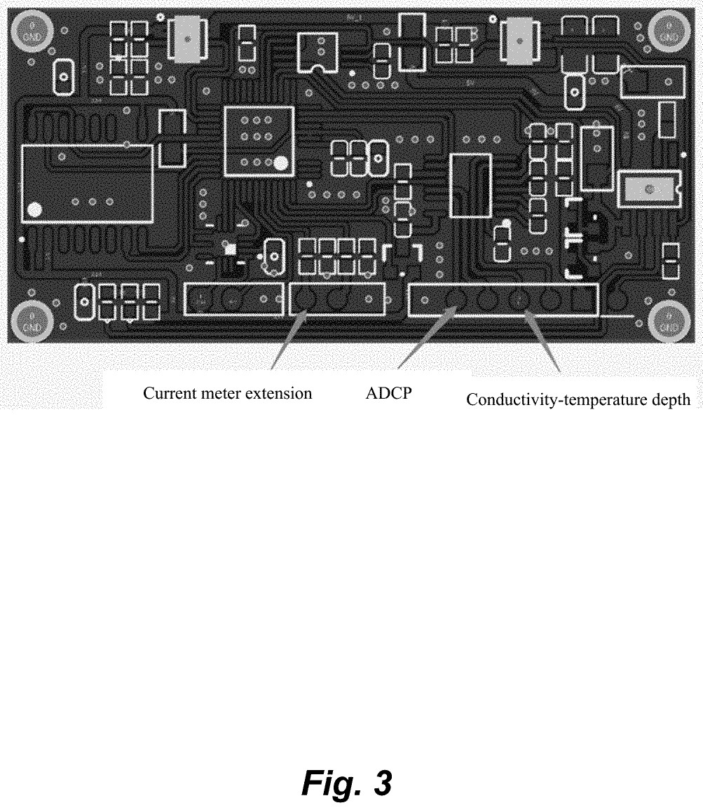

FIG. 1 is a schematic diagram of an on-duty circuit using an STM8L solution; FIG. 2 is a schematic diagram of a single-mode multi-card Beidou module circuit board; and FIG. 3 is a schematic design diagram of a data acquisition board.

An on-duty circuit module awakens a data acquisition module and a satellite communication module periodically, and the data acquisition module transmits acquired data to the satellite communication module. The on-duty circuit module, the satellite communication module and the data acquisition module normally operate in a low-power hibernation state. After awakened, the data acquisition module acquires data, and then transmits the data to the satellite communication module, and then operates in a low-power hibernation state. After receiving the data, the data acquisition module operates in a low-power hibernation state.

The above description is only the preferred implementation of the present invention and is not intended to limit the present invention in any form. Any simple modifications and equivalent changes and modifications made to the above implementation according to the technical essence of the present invention are within the scope of the technical solution of the present invention.

What is claimed is:

1. A system for real-time transmission of large-capacity of a deep-sea subsurface mooring based on a Beidou satellite, wherein data transmission is implemented by a mechanism of single module multi-card switching operation and dynamic subcontracting transmission, the system comprising:
a receiving module connected to a fixed card and configured to receive state information on whether the data transmission is successful;
a corresponding effective bidirectional response verification mechanism configured to ensure integrity and real-time property of the data transmission;
a subsurface mooring end antenna and a land-based antenna having a network analyzer, the network analyzer configured to:
perform secondary matching on parameters such as frequency offset and impedance of the subsurface mooring end antenna and the land-based antenna, and
effectively intercept original data;
an arithmetic coding and dictionary coding module configured to compress data;
an acquisition board terminal configured to process the original valid data, the original valid data being compressed to a maximum of one third of the original valid data such that the original valid data is suitable for real-time transmission of large-capacity of the deep-sea subsurface mooring, the original valid data is extended into a parallel mode of multiple single-mode multi-card modules, and the original valid data being is suitable for low power consumption design of a deep-sea subsurface mooring mobile platform;
a processor with a low power consumption MCU;
a low power consumption on-duty circuit, a power consumption being less than 5 uA when the system is in a sleep state; and
a Beidou communication module configured to be awakened by timing of an observation device and a data acquisition board.

2. The system for real-time transmission of large-capacity of a deep-sea subsurface mooring based on a Beidou satellite according to claim 1, wherein the Beidou communication module implements the mechanism of dynamic subcontracting transmission, using a sliding window protocol to reduce working time of the Beidou communication module to a minimum; the sliding window protocol including:
a sender window, wherein a sender maintains a serial number of a continuous frame allowed to be sent, which is called a sending window; at the same time,
a receiver window, wherein a receiver maintains a serial number of a continuous frame allowed to be received, which is called a receiving window
wherein upper and lower bounds of the serial numbers of the sending window and the receiving window are not necessarily the same,
wherein the serial number in the sending window represents those frames that have been sent but have not been confirmed, and
wherein the sliding window protocol provides a reliable flow control mechanism for data transmission between end-to-end devices.

3. The system for real-time transmission of large-capacity of a deep-sea subsurface mooring based on a Beidou satellite according to claim 1, wherein the system is suitable for small-volume design of the deep-sea subsurface mooring mobile platform by separating a communication module board from an SIM card board, and superposing double-layer circuit boards to reduce the overall volume of the module;
wherein each single-mode multi-card module retains all functional parameters of a single card;
wherein the system is configured to:
provide continuous positioning and speed measurement capability for users; and
perform high-security level position reporting without information transmission wherein the continuous positioning and speed measurement capability and the high-security level position reporting without information transmission are integrated to be embedded into each other and mutually enhanced.

4. The system for real-time transmission of large-capacity of a deep-sea subsurface mooring based on a Beidou satellite according to claim 1, wherein a data acquisition system includes:
an acquisition board interface, the interface being a universal RS232 interface, and being compatible with a 75 kHz ADCP;
a conductivity-temperature-depth sensor; and
a deep-sea single point current meter for data acquisition; and
wherein an overwater acquisition board and the Beidou single-mode multi-card communication module are configured to determine bidirectional communication to facilitate subsequent control over various parameters of sensors through a remote server.
